(19) United States
(12) Patent Application Publication
(10) Pub. No.: US 2014/0132078 A1
(43) Pub. Date: May 15, 2014

(54) WIRELESS POWER TRANSMITTER

(71) Applicant: ADVANTEST CORPORATION, Tokyo (JP)

(72) Inventors: Yuki ENDO, Tokyo (JP); Yasuo FURUKAWA, Tokyo (JP)

(73) Assignee: ADVANTEST CORPORATION, Tokyo (JP)

(21) Appl. No.: 14/094,732

(22) Filed: Dec. 2, 2013

Related U.S. Application Data
(63) Continuation of application No. PCT/JP2012/003189, filed on May 16, 2012.

(30) Foreign Application Priority Data
Jun. 3, 2011 (JP) 2011-125534

(51) Int. Cl. H01F 38/14

(52) U.S. Cl. CPC H01F 38/14
USPC 307/104

(57) ABSTRACT

A wireless power supply apparatus includes a resonance circuit and a multi-tone power supply, and is configured to transmit an electric power signal comprising at least one from among an electric field, a magnetic field, and an electromagnetic field. The resonance circuit includes a transmission coil and a resonance capacitor connected in series. The multi-tone power supply is configured to generate a multi-tone signal by superimposing multiple sine wave signals having respective frequencies, and to output the multi-tone signal thus generated to the resonance circuit.

### CROSS-REFERENCE TO RELATED APPLICATIONS

This application is a continuation of International Patent Application No. PCT/JP2012/003189 filed on May 16, 2012, which claims priority to Japanese Patent Application No. 2011-125534 filed on Jun. 3, 2011, all of which are hereby expressly incorporated by reference into the present application.

### BACKGROUND OF THE INVENTION

1. Field of the Invention

The present invention relates to a wireless power supply technique.

2. Description of the Related Art

In recent years, wireless (contactless) power transmission has been receiving attention as a power supply technique for electronic devices such as cellular phone terminals, laptop computers, etc., or for electric vehicles. Wireless power transmission can be classified into three principal methods using an electromagnetic induction, an electromagnetic wave reception, and an electric field/magnetic field resonance.

The electromagnetic induction method is employed to supply electric power at a short range (several cm or less), which enables electric power of several hundred watts to be transmitted in a band that is equal to or lower than several hundred kHz. The power use efficiency thereof is on the order of 60% to 98%. In a case in which electric power is to be supplied over a relatively long range of several meters or more, the electromagnetic wave reception method is employed. The electromagnetic wave reception method allows electric power of several watts or less to be transmitted in a band between medium waves and microwaves. However, the power use efficiency thereof is small. The electric field/magnetic field resonance method has been receiving attention as a method for supplying electric power with relatively high efficiency at a middle range on the order of several meters (A. Karalis, J. D. Joannopoulos, M. Soljacic, “Efficient wireless non-radiative mid-range energy transfer” ANNALS of PHYSICS Vol. 323, January 2008, pp. 34-48)

FIG. 1 is a diagram which shows an example of a wireless power supply system. A wireless power supply system 2r includes a wireless power supply apparatus 4r and a wireless power receiving apparatus 6r.

The wireless power supply apparatus 4r includes a transmission coil L_{TX}, a resonance capacitor C_{TX}, and an AC power supply 20r. The AC power supply 20r is configured to generate an electric signal S2 having a transmission frequency f₁. The resonance capacitor C_{TX} and the transmission coil L_{TX} form a resonance circuit having a resonance frequency that is tuned to the frequency of the electric signal S2. The transmission coil L_{TX} is configured to output an electric power signal S1. As such an electric power signal S1, the wireless power supply system 2r uses the near-field components (electric field, magnetic field, or electromagnetic field) of electromagnetic waves that have not yet become radio waves.

The wireless power receiving apparatus 6r includes a reception coil L_{RX}, a resonance capacitor C_{RX}, and a load 3. The resonance capacitor C_{RX}, the reception coil L_{RX}, and the load 3 form a resonance circuit. The resonance frequency of the resonance circuit thus formed is tuned to the frequency of the electric power signal S1.

FIG. 2 is a graph which shows the transmission characteristics (S21) of the power supply system shown in FIG. 1, which represents electric power transmission from the AC power supply to the load. When the distance or otherwise the direction between the transmission coil L_{TX} and the reception coil T_{RX} changes, the degree of coupling K between the two coils changes. When the degree of coupling K becomes high, the waveform of the transmission characteristics S21 changes such that a single peak is split into two peaks. The peak interval changes according to the degree of coupling K.

With such a conventional power supply system 2r, by adjusting the capacitances of the resonance capacitors C_{TX} and C_{RX}, such an arrangement allows the resonance frequency of the receiver-side resonance circuit and the resonance frequency of the transmitter-side resonance circuit to be tuned to be in the vicinity of a peak at which high transmission efficiency can be obtained.

However, in a situation in which the distance between the power supply apparatus 4r and the power receiving apparatus 6r changes over time, i.e., in a situation in which the degree of coupling K changes over time, it is difficult to adjust the resonance capacitors C_{TX} and C_{RX} such that they follow the change in the degree of coupling K.

### SUMMARY OF THE INVENTION

The present invention has been made in order to solve such a problem. Accordingly, it is an exemplary purpose of an embodiment of the present invention to provide a wireless power supply apparatus which is capable of maintaining high-efficiency electric power transmission even if the degree of coupling between a transmission coil and a reception coil changes.

An embodiment of the present invention relates to a wireless power supply apparatus configured to transmit an electric power signal comprising any one from among an electric field, a magnetic field, and an electromagnetic field. The wireless power supply apparatus comprises: a resonance circuit comprising a transmission coil and a resonance capacitor connected in series; and a multi-tone power supply configured to output, to the resonance circuit, a multi-tone signal obtained by superimposing sine wave signals having multiple discrete frequencies.

Such an embodiment provides electric power transmission using frequencies which provide high efficiency without changing the resonance frequency set for the power supplying side and the power receiving side even in a situation in which a frequency band peak which provide high transmission efficiency splits according to a change in the degree of coupling.

With an embodiment, the multi-tone power supply may comprise: a bridge circuit connected to the resonance circuit; a power supply circuit configured to output a power supply voltage to the bridge circuit; a digital multi-tone signal generating unit configured to generate a digital multi-tone signal having a waveform obtained by superimposing the multiple sine wave signals having the respective frequencies; a bitstream signal generating unit configured to generate a bitstream signal that corresponds to the digital multi-tone signal; and a driver circuit configured to drive the bridge circuit according to the bitstream signal.

Such an embodiment is capable of generating the multi-tone signal with low energy loss.

With an embodiment, the bitstream signal generating unit may comprise a bandpass delta-sigma modulator configured to generate the bitstream signal by performing delta-sigma modulation on the digital multi-tone signal.

The quantization noise is shaped such that it is distributed in a frequency range that is higher than that of the multiple frequency components. The high-frequency signal is filtered by the resonance circuit. Thus, such an arrangement is capable of suppressing the transmission of noise via an antenna.

Also, the digital multi-tone signal generating unit may comprise an inverse fast Fourier transformer configured to calculate an inverse Fourier transform of the frequency data which represents the multiple frequencies so as to generate the digital multi-tone signal.

Also, the power supply circuit may be configured to modulate the power supply voltage according to the digital multi-tone signal.

In a case in which the power supply voltage is configured as a fixed voltage, the multi-tone signal has a completely square waveform. Thus, the spectrum of the multi-tone signal contains a large number of sideband components. In contrast, by appropriately modulating the power supply voltage according to the waveform of the multi-tone signal, such an arrangement is capable of suppressing such sideband components. Thus, such an arrangement is capable of further suppressing out-of-band noise, or otherwise providing increased efficiency.

Also, the multi-tone power supply may be configured to superimpose the multiple sine wave signals having the respective frequencies such that the multi-tone signal is configured to have a small crest factor.

Such an embodiment allows the multiple frequency components of the multi-tone signal to have a large amplitude. This allows the transmittable electric power to be increased.

Another embodiment of the present invention relates to a wireless power supply system. The wireless power supply system comprises: a wireless power supply apparatus according to any one of the aforementioned embodiments, configured to transmit an electric power signal comprising any one from among an electric field, a magnetic field, and an electromagnetic field; and a wireless receiving apparatus configured to receive the electric power signal.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram which shows an example of a wireless power supply system;

FIG. 2 is a graph which shows the transmission characteristics (S21) of the power supply system shown in FIG. 1, which represents electric power transmission from an AC power supply to a load;

FIG. 3 is a block diagram which shows a configuration of a wireless power supply apparatus according to an embodiment;

FIG. 4 is a circuit diagram which shows a specific configuration of a wireless power supply apparatus;

FIGS. 5A through 5C are diagrams each showing the operation of the wireless power supply apparatus according to the embodiment;

FIG. 6 is a circuit diagram which shows a part of a configuration of a wireless power supply apparatus according to a second modification; and

FIG. 7 is a circuit diagram which shows a part of a configuration of a wireless power supply apparatus according to a fourth modification.

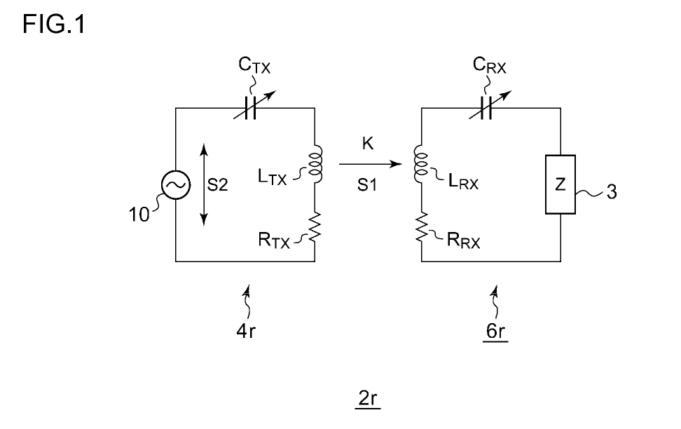

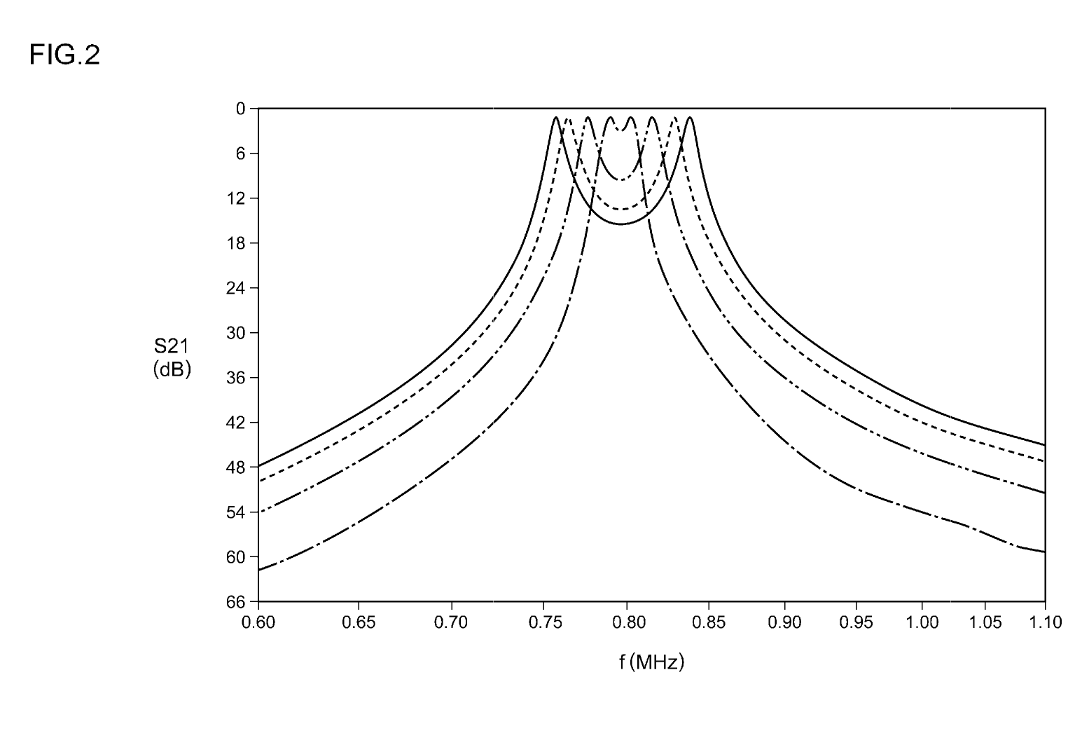

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not substantially affect the electric connection therebetween, or that does not damage the functions or effects of the connection therebetween, in addition to a state in which the member A is physically and directly connected to the member B.

Similarly, the state represented by the phrase “the member C is provided between the member A and the member B” includes a state in which the member A is indirectly connected to the member C, or the member B is indirectly connected to the member C via another member that does not substantially affect the electric connection therebetween, or that does not damage the functions or effects of the connection therebetween, in addition to a state in which the member A is directly connected to the member C, or the member B is directly connected to the member C.

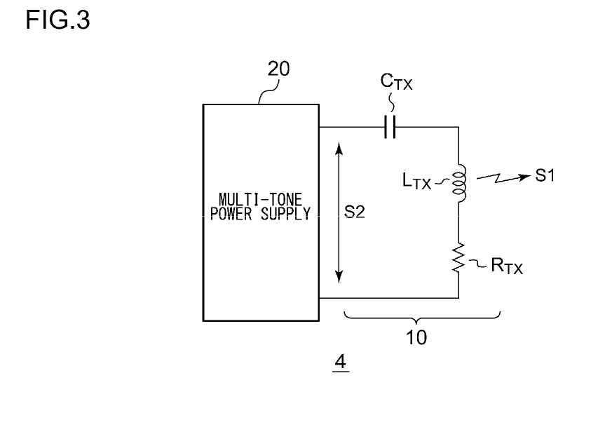

FIG. 3 is a block diagram which shows a configuration of a wireless power supply apparatus 4 according to an embodiment. The power supply apparatus 4 includes a resonance circuit 10 and a multi-tone power supply 20, and is configured to output an electric power signal S1 to an unshown wireless power receiving apparatus. The electric power signal S1 is configured as a near-field component (electric field, magnetic field, or electromagnetic field) of electromagnetic waves that has not become radio waves.

The resonance circuit 10 includes a transmission coil L_{TX} and a resonance capacitor C_{TX} connected in series. The resistor R_{TX} represents a resistance component of the resonance circuit.

The multi-tone power supply 20 is configured to be capable of outputting, to the resonance circuit 10, a multi-tone signal S2 obtained by superimposing sine wave signals having discrete frequencies f₁ through f_{N}. Here, N represents an integer of 2 or more. The multiple frequencies f₁ through f_{N} are determined such that they are distributed around a center that matches the resonance frequency f_{R} of the resonance circuit 10.

The multi-tone power supply 20 preferably superimposes the multiple sine wave signals having the multiple respective frequencies f₁ through f_{N} such that their respective phases result in the multi-tone signal S2 exhibiting a low crest factor.

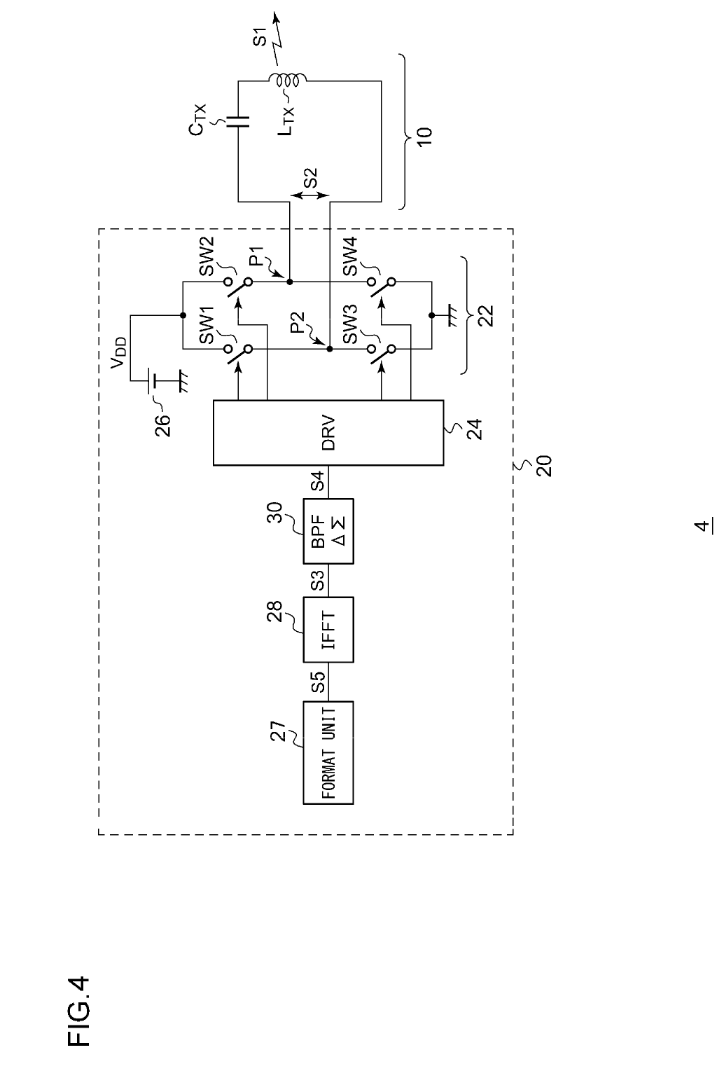

FIG. 4 is a circuit diagram which shows a specific configuration of the wireless power supply apparatus 4.

The multi-tone power supply 20 includes a bridge circuit 22, a driver circuit 24, a power supply 26, a format unit 27, a digital multi-tone signal generating unit 28, and a bit stream signal generating unit 30.

The output terminals P1 and P2 of the bridge circuit 22 are connected to the resonance circuit 10. In FIG. 4, the bridge circuit 22 is configured as an H-bridge circuit, and includes four switches SW1 through SW4.

The power supply 26 is configured to output a power supply voltage V_{DD} to the bridge circuit 22.

The format unit 27 is configured to generate frequency data S5 which indicates the multiple frequencies f₁ through f_{N} to be contained as the frequency components of the multi-tone signal S2 to be generated by the multi-tone power supply 20. The frequency data S5 may be configured as complex data containing the amplitude data and the phase data of the respective frequencies f₁ through f_{N}. In this case, the phase data is generated such that the multi-tone signal S2 is configured to have a low crest factor.

The digital multi-tone signal generating unit 28 is configured to generate a digital multi-tone signal S3 having a waveform obtained by superimposing the sine wave signals having the multiple frequencies f₁ through f_{N} indicated by the frequency data S5. The digital multi-tone signal generating unit 28 includes an inverse fast Fourier transformer configured to calculate an inverse Fourier transform of the frequency data S5 so as to generate the digital multi-tone signal S3.

The bitstream signal generating unit 30 is configured to generate a bitstream signal S4 according to the digital multi-tone signal S3. For example, the bitstream signal generating unit 30 includes a bandpass delta-sigma modulator configured to generate the bitstream signal S4 by performing delta-sigma modulation on the digital multi-tone signal S3.

Such a bandpass delta-sigma modulator may be configured using known techniques. The bandpass delta-sigma modulator is designed such that the bandpass center frequency fc of a bandpass filter included within the bandpass delta-sigma modulator matches the resonance frequency f_{R} of the resonance circuit 10. By means of oversampling, the bandpass delta-sigma modulator is configured to generate the bitstream signal S4 at a rate that is four times the bandpass center frequency fc.

The digital multi-tone signal S3, which is input to the bitstream signal generating unit 30, involves quantization noise which is uniformly distributed over the entire frequency band. The digital multi-tone signal S3 is shaped (subjected to noise shaping) by the bandpass delta-sigma modulator such that the quantization noise exhibits a value that is at a minimum in the vicinity of the frequency fc, and that increases as the frequency changes from the frequency fc.

The driver circuit 24 is configured to drive the switches SW1 through SW4 of the bridge circuit according to the bitstream signal S4.

Specifically, when the bitstream signal S4 is a first level (e.g., high level), the driver circuit 24 turns on a pair of switches SW1 and SW4. When the bitstream signal S4 is a second level (e.g. low level), the driver circuit 24 turns on a pair of switches SW2 and SW3.

In a case in which the multi-tone power supply 20 is configured employing such a bridge circuit 22, the amplitude of the multi-tone signal S2 is limited by the power supply voltage V_{DD} generated by the power supply 26. By optimizing the phases of the respective frequency signals such that the multi-tone signal S2 exhibits a low crest factor, such an arrangement allows the amplitude to be increased for each frequency component, thereby allowing the transmittable electric power to be increased. The same can be said of an arrangement in which the multi-tone power supply 20 is configured employing an analog amplifier.

The above is the configuration of the wireless power supply apparatus 4.

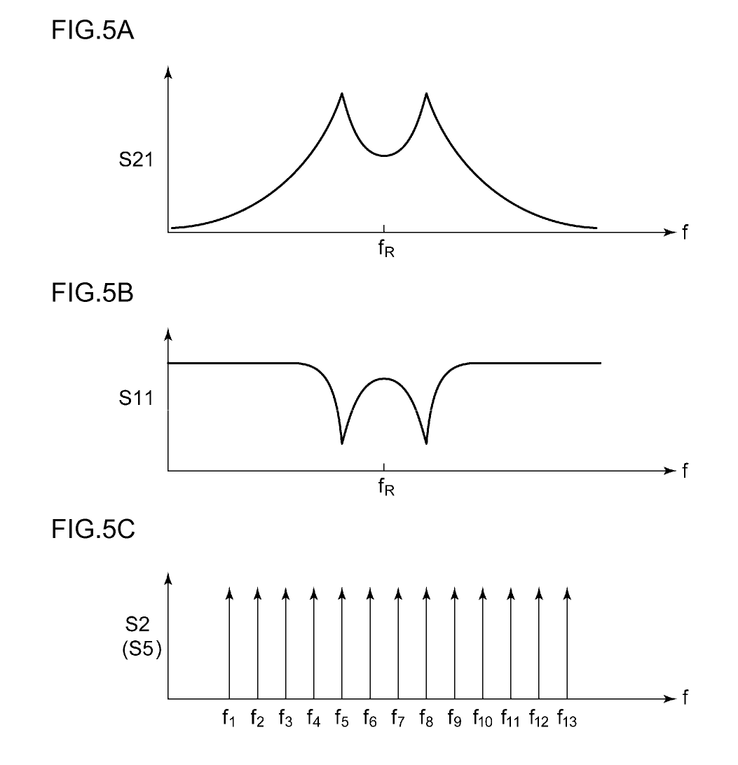

Next, description will be made regarding the operation thereof. FIGS. 5A through 5C are diagrams each showing the operation of the wireless power supply apparatus 4 according to an embodiment. The degree of coupling K between the transmission coil L_{TX} and the reception coil L_{RX} changes according to the distance and the direction between the wireless power supply apparatus 4 and the wireless power receiving apparatus 6. With such an arrangement, the S parameter (transmission characteristics) S21, which represents the characteristics of electric power transmission from the multi-tone power supply 20 to the load of the wireless power receiving apparatus 6, changes according to the degree of coupling K.

FIGS. 5A and 5B show the S parameter S21 (transmission characteristics) and the S parameter S11 (reflection characteristics) at a given degree of coupling K. The multi-tone power supply 20 is configured to generate the multi-tone signal S2 containing multiple frequencies f₁ through f₁₃.

The wireless power supply apparatus 4 is capable of supplying electric power to the wireless power receiving apparatus 6 with high efficiency using, from among the multiple frequencies f₁ through f₁₃, the frequencies f5 and f8 at which the S parameter S21 exhibits a high value. It should be noted that the reflection ratio (S11) is in the vicinity of 1 at the other frequencies f₁ through f₄, f₆, f₇, and f₉ through f₁₃. Thus, the current does not flow through the resonance circuit 10 at these frequencies. Thus, the other frequency components f₁ through f₄, f₆, f₇, and f₉ through f₁₃ do not lead to a problem of energy loss.

The above is the operation of the wireless power supply apparatus 4.

With the wireless power supply apparatus 4 according to the embodiment, such an arrangement provides high-efficiency power supply using the optimum frequencies for the S parameter from among the frequency components contained in the multi-tone signal S2 even in a case in which the frequency at which the S parameter 21 exhibits a high value changes due to change in the degree of coupling K.

Furthermore, in a case in which a single wireless power supply apparatus 4 is to supply electric power to multiple wireless power receiving apparatuses 6, such an arrangement provides power supply by means of the optimum frequency components for each of the multiple wireless power supply apparatuses 6.

Furthermore, the wireless power supply apparatus 4 shown in FIG. 3 is configured to employ the bridge circuit to generate the multi-tone signal S2. Thus, such an arrangement is capable of generating the electric power signal S1 with high efficiency as compared with an arrangement employing a linear amplifier.

Moreover, a bandpass delta-sigma modulator is employed in the bitstream signal generating unit 30, the center frequency fc of which matches the resonance frequency f_{R} of the resonance circuit 10. As a result, quantization noise in the digital multi-tone signal S3 is distributed over a range that is outside the band of the bandpass filter. Such an arrangement is capable of appropriately performing filtering of the digital multi-tone signal S3 by means of the resonance circuit 10.

Description has been made regarding the present invention with reference to the embodiments. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

### [Modification 1]

Also, the power supply 26 may be configured to modulate the power supply voltage V_{DD} according to the digital multi-tone signal S3. In this case, the power supply 26 and the bridge circuit 22 can be regarded as a polar modulator.

In a case in which the power supply voltage V_{DD} is configured as a fixed voltage, the multi-tone signal S2a has a completely square waveform. Thus, the spectrum of the multi-tone signal S2a contains a large number of sideband components. In contrast, by appropriately modulating the power supply voltage V_{DD} according to the waveform of the multi-tone signal S2, such a modification is capable of suppressing such sideband components. Thus, such a modification is capable of further suppressing noise outside the band, or otherwise providing increased efficiency.

### [Modification 2]

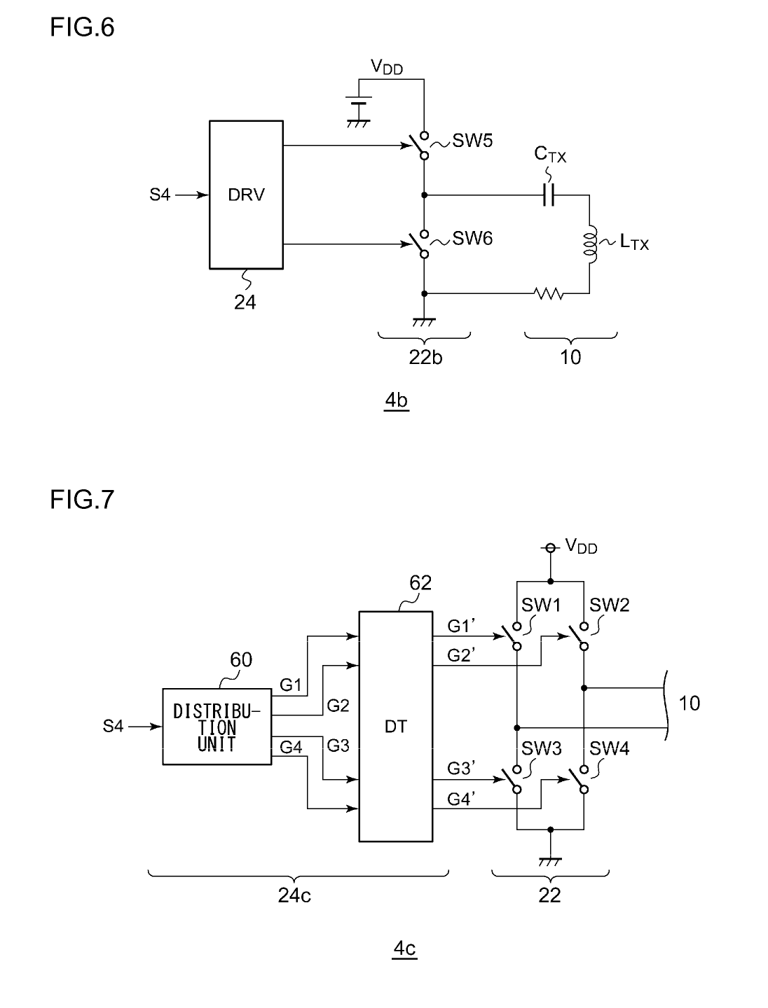

FIG. 6 is a circuit diagram which shows a part of a configuration of a wireless power supply apparatus 4b according to a second modification. The wireless power supply apparatus 4b includes a half-bridge circuit as a bridge circuit 22b. When the bitstream signal S4 is a first level (high level), the driver circuit 24 turns on a switch SW5, and when the bitstream signal S4 is a second level (low level), the driver circuit 24 turns on a switch SW6.

Such a modification also provides the same advantages as in an arrangement employing an H-bridge circuit.

### [Modification 3]

The multi-tone power supply 20 may be configured as an analog linear amplifier. For example, the multi-tone power supply 20 may be configured including a D/A converter configured to convert the digital multi-tone signal S3 into an analog multi-tone signal, and an analog amplifier (buffer) configured to output the output signal of the D/A converter to the resonance circuit 10. Such a configuration allows such a modification to output, to the resonance circuit 10, a multi-tone signal obtained by superimposing sine wave signals of multiple frequencies.

### [Modification 4]

FIG. 7 is a circuit diagram which shows a part of a configuration of a wireless power supply apparatus 4c according to a fourth modification. The driver circuit 24c includes a distribution unit 60 and a dead time setting unit 62. The distribution unit 60 is configured to generate gate signals G1 through G4 for the respective switches SW1 through SW4, according to the bitstream signal S4. For example, when the bitstream signal S4 is high level, the gate signals G1 and G4 are each set to a level which functions as an instruction to turn on the switches SW1 and SW4. When the bitstream signal S4 is low level, the gate signals G2 and G3 are each set to a level which functions as an instruction to turn on the switches SW2 and SW3.

For each cycle of the bitstream signal, the dead time setting unit 62 is configured to reduce, by a predetermined dead time T_{DT}, the on time set for the respective switches SW1 through SW4. With such an arrangement, during a period of dead time T_{DT}, all the switches SW1 through SW4 are turned off. The dead time setting unit 62 is configured to be capable of adjusting the length of the dead time T_{DT}.

The dead time T_{DT} is used to control the resonance frequency, in addition to being used to suppress a so-called through current. The dead time setting unit 62 is configured to adjust the length of the dead time T_{DT} such that partial resonance occurs between the resonance circuit 10 and the multi-tone signal S2, i.e., the resonance current I_{L} that corresponds to the multi-tone signal S2.

Using such partial resonance, such a modification is capable of changing the effective resonance frequency of the resonance circuit 10 according to the length of the dead time T_{DT} without changing the circuit constants of the transmission coil L_{TX} and the resonance capacitor C_{TX} of the resonance circuit 10.

### [Modification 5]

Given information may be superimposed on the multi-tone signal S2. The superimposition of such information can be performed by applying amplitude modulation, phase modulation, or the like, to the sine wave signals of the respective frequencies to be superimposed.

### [Modification 6]

Description has been made regarding an arrangement employing delta-sigma modulation. Also, the bridge circuit 22 may be driven using other modulation methods such as pulse width modulation.

While the preferred embodiments of the present invention have been described using specific terms, such description is for illustrative purposes only, and it is to be understood that changes and variations may be made without departing from the spirit or scope of the appended claims.

What is claimed is:

1. A wireless power supply apparatus configured to transmit an electric power signal comprising any one from among an electric field, a magnetic field, and an electromagnetic field, the wireless power supply apparatus comprising:
a resonance circuit comprising a transmission coil; and
a power supply configured to output, to the resonance circuit, a multi-tone signal obtained by superimposing sine wave signals having multiple discrete frequencies.

2. The wireless power supply apparatus according to claim 1, wherein the power supply comprises:
a bridge circuit connected to the resonance circuit;
a power supply circuit configured to output a power supply voltage to the bridge circuit;
a digital multi-tone signal generating unit configured to generate a digital multi-tone signal having a waveform obtained by superimposing the multiple sine wave signals having the respective frequencies;
a bitstream signal generating unit configured to generate a bitstream signal that corresponds to the digital multi-tone signal; and
a driver circuit configured to drive the bridge circuit according to the bitstream signal.

3. The wireless power supply apparatus according to claim 2, wherein the bitstream signal generating unit comprises a bandpass delta-sigma modulator configured to generate the bitstream signal by performing delta-sigma modulation on the digital multi-tone signal.

4. The wireless power supply apparatus according to claim 2, wherein the digital multi-tone signal generating unit comprises an inverse fast Fourier transformer configured to calculate an inverse Fourier transform of the frequency data which represents the multiple frequencies so as to generate the digital multi-tone signal.

5. The wireless power supply apparatus according to claim 2, wherein the power supply circuit is configured to modulate the power supply voltage according to the digital multi-tone signal.

6. The wireless power supply apparatus according to claim 1, wherein the power supply is configured to superimpose the multiple sine wave signals having the respective frequencies such that the multi-tone signal is configured to have a small crest factor.

7. The wireless power supply apparatus according to claim 1, wherein the resonance circuit further comprises a resonance capacitor connected in series to the transmission coil.

8. A wireless power supply system comprising:
the wireless power supply apparatus according to claim 1, configured to transmit an electric power signal comprising any one from among an electric field, a magnetic field, and an electromagnetic field; and
a wireless receiving apparatus configured to receive the electric power signal.
